(19) United States
(12) Patent Application Publication
(10) Pub. No.: US 2021/0158798 A1
(43) Pub. Date: May 27, 2021

(54) INTERMEDIARY VIRTUAL ASSISTANT FOR IMPROVED TASK FULFILLMENT

(71) Applicant: International Business Machines Corporation, Armonk, NY (US)

(72) Inventors: ROY ABITBOL, ZURIT (IL); HAROLD JEFFREY SHIP, MITZPE NETOFA (IL); AVI YAELI, RAMOT MENASHE (IL)

(21) Appl. No.: 16/695,232

(22) Filed: Nov. 26, 2019

(51) Int. Cl. G10L 15/06; G10L 15/22; G10L 15/16; G10L 13/027

(52) U.S. Cl. CPC G10L 15/063; G10L 15/22; G10L 2015/223; G10L 13/027; G10L 15/16

(57) ABSTRACT

A system including: A main virtual assistant (VA) that is configured to operate a back-end system according to instructions. An intermediary VA that is configured to: learn, by conversing with the human user and by analyzing responses from the main VA to the human user, to perform a task that is associated with the back-end system; hold a conversation with the main VA, wherein, in the conversation, the instructions are formulated and relayed from the intermediary VA to the main VA based on the learning and on further conversing with the human user, such that the main VA operates the back-end system according to the instructions; and formulate and relay responses to the instructions from the main VA to the human user.

### BACKGROUND

The invention relates to the field of virtual assistants.

A virtual assistant (VA), sometimes termed “intelligent virtual assistant” (IVA) or “intelligent personal assistant” (IPA), is a software (or a combined software-hardware) agent, largely based on artificial intelligence (AI), that can perform tasks or provide services for a human user based on commands or questions. VAs can interact with users in a number of ways, such as via textual chat (in which the VA is often called a “chat bot”) or voice chat (in which the VA is often called a “voice assistant”).

VAs typically interface with various back-end systems to fetch information to be relayed to the user, or to store information received from the user. For example, today's VAs can interface with weather service systems, calendar systems, email systems, database systems, and various enterprise computer systems.

Prominent VA platforms include “Alexa” by Amazon.com, Inc., of Seattle, Wash.; “Google Assistant” by Google LLC, of Mountain View, Calif.; “Cortana” by Microsoft Corporation, of Redmond, Wash.; and “Siri” by Apple, Inc., of Cupertino, Calif. Each of these platforms provides the means to implement specific software programs (termed “skills” in Alexa and Cortana, “apps” in Google Assistant, and “shortcuts” in Siri) that can carry out specific sets of actions, so that these software programs, together with their respective VA platform, can serve as fully-functional VAs.

The foregoing examples of the related art and limitations related therewith are intended to be illustrative and not exclusive. Other limitations of the related art will become apparent to those of skill in the art upon a reading of the specification and a study of the figures.

### SUMMARY

The following embodiments and aspects thereof are described and illustrated in conjunction with systems, tools and methods which are meant to be exemplary and illustrative, not limiting in scope.

One embodiment is directed to a system that comprises: a main virtual assistant (VA) that is configured to operate a back-end system according to instructions; and an intermediary VA that is configured to: learn, by conversing with a human user and by analyzing responses from said main VA to the human user, to perform a task that is associated with the back-end system; hold a conversation with said main VA, wherein, in the conversation, the instructions are formulated and relayed from said intermediary VA to said main VA based on the learning and on further conversing with the human user, such that said main VA operates the back-end system according to the instructions; and formulate and relay responses to the instructions from said main VA to the human user.

Another embodiment relates a method that comprises: accessing a main virtual assistant (VA) that is configured to operate a back-end system according to instructions; and operating an intermediary VA to: learn, by conversing with a human user and by analyzing responses from the main VA to the human user, to perform a task that is associated with the back-end system; hold a conversation with the main VA, wherein, in the conversation, the instructions are formulated and relayed from the intermediary VA to the main VA based on the learning and on further conversing with the human user, such that the main VA operates the back-end system according to the instructions; and formulate and relay responses to the instructions from the main VA to the human user.

A further embodiment is drawn to a computer program product comprising a non-transitory computer-readable storage medium having program code embodied therewith, the program code executable by at least one hardware processor to: access a main virtual assistant (VA) that is configured to operate a back-end system according to instructions; and operate an intermediary VA to: learn, by conversing with a human user and by analyzing responses from the main VA to the human user, to perform a task that is associated with the back-end system; hold a conversation with the main VA, wherein, in the conversation, the instructions are formulated and relayed from the intermediary VA to the main VA based on the learning and on further conversing with the human user, such that the main VA operates the back-end system according to the instructions; and formulate and relay responses to the instructions from the main VA to the human user.

In some embodiments, the learning by said intermediary VA comprises learning a model which comprises: entities, and fields that can store values for each of the entities.

In some embodiments, the instructions are formulated and relayed to said main VA based on the learned model.

In some embodiments, the instructions are with respect to implicit fields and values that are not explicitly mentioned in an utterance of the human user, and the implicit fields and values are deduced from the learned model.

In some embodiments, said intermediary VA is configured with a vocabulary that, when used in utterances by the human user, enables said intermediary VA to deduce the implicit fields and values.

In some embodiments, the back-end system is configured to perform at least one of: store data in a computerized database; retrieve data from a computerized database; and provide information to the human user.

In some embodiments, said intermediary VA is further configured to interface with said main VA using an API (Application Program Interface) of said main VA.

In some embodiments, each of said main VA and said intermediary VA comprises: at least one hardware processor, and a non-transitory computer-readable storage medium having program code embodied therewith, the program code executable by said at least one hardware processor to automatically perform the actions that the main VA or the intermediary VA, respectively, is configured to perform.

In some embodiments, the main VA comprises: at least one hardware processor, and a non-transitory computer-readable storage medium having program code embodied therewith, the program code executable by said at least one hardware processor to automatically operate the back-end system according to the instructions; and the intermediary VA comprises: a different at least one hardware processor, and a different non-transitory computer-readable storage medium having program code embodied therewith, the program code executable by said different at least one hardware processor to automatically perform the learning, the holding of the conversation, and the formulating and relaying of the responses.

In addition to the exemplary aspects and embodiments described above, further aspects and embodiments will become apparent by reference to the figures and by study of the following detailed description.

### BRIEF DESCRIPTION OF THE FIGURES

Exemplary embodiments are illustrated in referenced figures. Dimensions of components and features shown in the figures are generally chosen for convenience and clarity of presentation and are not necessarily shown to scale. The figures are listed below.

FIG. 1 is a block diagram of an exemplary system for automated virtual assistance, according to an embodiment.

FIG. 2 is a flow diagram of an exemplary method for automated virtual assistance, according to an embodiment.

### DETAILED DESCRIPTION

Disclosed herein is an intermediary VA that is configured to interoperate with a standard, off-the-shelf, general-purpose VA (such as those mentioned in the background section above) in order to enrich its capabilities. Evolving business needs greatly outpace the rate at which businesses can customize and tailor off-the-shelf VAs for their specific needs, thus giving up on much potential to make these businesses more efficient. It is also impractical for providers of such off-the-shelf VAs to customize their products to the individual needs of numerous business.

The intermediary VA disclosed herein accesses and interoperates with such off-the-shelf VA (hereinafter “main” VA), by intermediating conversations between a human user and a provided main VA. This involves relaying the user's utterances and the main VA's responses back and forth, sometimes verbatim and sometimes with certain adaptations, as is further discussed below.

At a learning stage, the intermediary VA may relay these utterances and responses verbatim, and use them to learn the task the user performs using the main VA. The learning of the task may include learning a model which includes entities and various fields of the entities into which values may be entered. For example, if the user uses the main VA to enter data (values) with respect to multiple items (entities) into a back-end database as she inspects these items in the field, then the intermediary VA may learn, just by listening in to the conversation between the user and the main VA, what type of entities are dealt with, what types of fields the values are entered into, what types of values can be entered, etc.

Then, after the model is learned, the intermediary VA can take over at least some of the conversations with the user, and make them more efficient than conversing directly with the main VA. For example, the intermediary VA can offer the user certain shortcuts to achieve the same result at the back-end system, such as by letting the user only implicitly mention various entities, fields, and values; the intermediary VA will then interpret these implicit mentions based on the model it had learned, and will relay an adapted message to the main VA in which the entities, fields, or values, as the case may be, are explicitly mentioned. The intermediary VA will also be able to conduct a conversation (including one or multiple “iterations” of utterance and response) with the main VA in the background, based on a single instruction or question by the user. The main VA will thus be able to operate the back-end system normally, as if the user provided full and explicit instructions as to all entities, fields, and/or values.

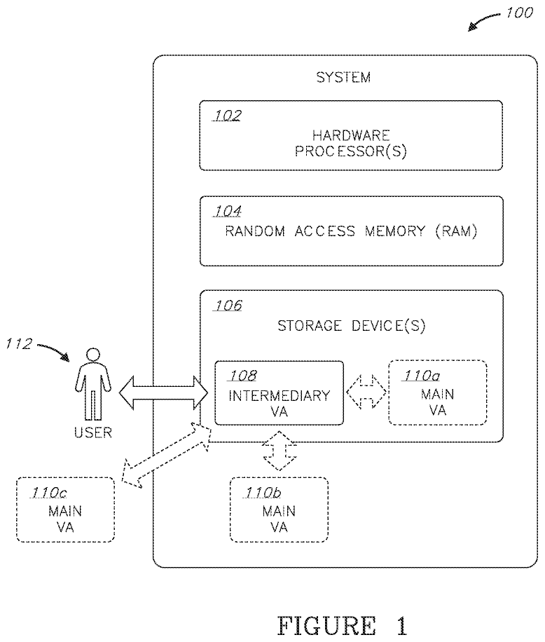

Reference is now made to FIG. 1, which shows a block diagram of an exemplary system 100 for automated virtual assistance, according to an embodiment. System 100 may include one or more hardware processor(s) 102, a random-access memory (RAM) 104, and one or more non-transitory computer-readable storage device(s) 106.

Storage device(s) 106 may have stored thereon program instructions and/or components configured to operate hardware processor(s) 102. The program instructions may include one or more software modules, such as an intermediary VA 108 module and optionally also a main VA 110a module. As an alternative to inclusion of the main VA on storage device(s) 106, it may be included separately 110b in system 100, or be disposed completely separately 110c from system 100, such as in its own computer system (not shown) that communicates with system 100 via a data bus or a computer network. For simplicity of discussion, present embodiments are described with reference to one system which includes both an intermediary VA and a main VA, but this semantic should not be interpreted as limiting the computing architecture that embodies these two VAs.

The software components may include an operating system having various software components and/or drivers for controlling and managing general system tasks (e.g., memory management, storage device control, power management, etc.), and facilitating communication between various hardware and software components.

System 100 may operate by loading instructions of intermediary VA 108 module (and optionally also of main VA 110a or 110b) into RAM 104 as they are being executed by processor(s) 102. The instructions may cause system 100 to intermediate between a human user 112 and main VA 110a/110b/110c module. As such, system 100 may function as an intermediary VA and/or as a main VA.

System 100 as described herein is only an exemplary embodiment of the present invention, and in practice may be implemented in hardware only, software only, or a combination of both hardware and software. System 100 may have more or fewer components and modules than shown, may combine two or more of the components, or may have a different configuration or arrangement of the components. System 100 may include any additional component enabling it to function as an operable computer system, such as a motherboard, data busses, power supply, a network interface card, etc. (not shown). Components of system 100 may be co-located or distributed (e.g., in a distributed computing architecture).

A back-end system, which fulfills the instructions of main VA 110a/110b/110c module, may be disposed separately from system 100 or be a sub-system thereof. Either way, such back-end system may include, for example, a computerized database in which data may be stored and from which data may be retrieved, a computerized system configured to provide information to users on demand (e.g., current weather, current driving conditions, etc.), an email server, a calendar server, and/or any other personal or enterprise-type computer system.

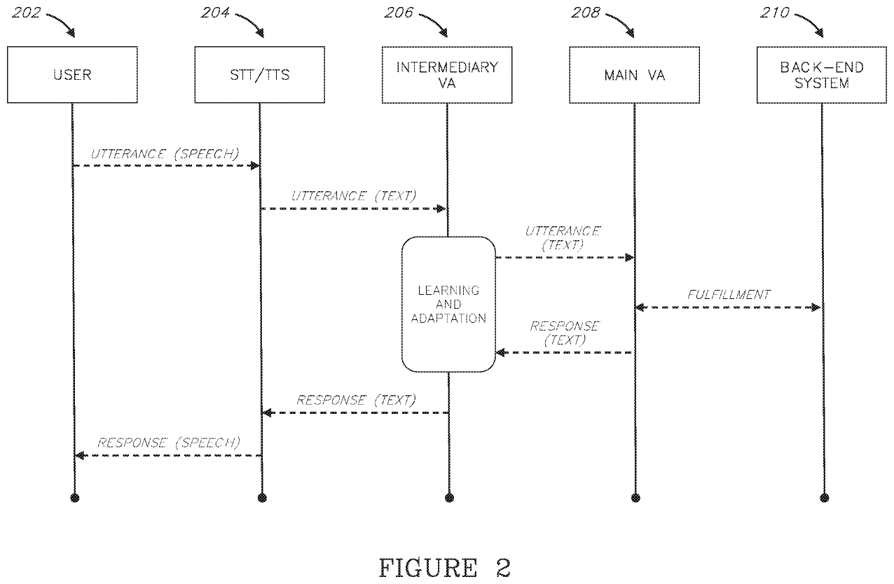

The instructions of intermediary VA module 108 are now discussed with reference to the flow diagram of FIG. 2, which illustrates a method for automated virtual assistance, in accordance with an embodiment.

Steps of the method may either be performed in the order they are discussed or in a different order (or even in parallel), as long as the order allows for a necessary input to a certain step to be obtained from an output of an earlier step. In addition, the steps of the method are performed automatically (e.g., by system 100 of FIG. 1), unless specifically stated otherwise.

The flow diagram of FIG. 2 illustrates a user 202, an SST/TTS engine(s) 204, an intermediary VA 206, a main VA 208, and a back-end system 210.

User 202 may be a human user who uses his or her voice to converse with main VA 208 (through intermediary VA 206, as will be discussed below). In an alternative embodiment, user 202 may use typed commands instead of speech, and view textual responses on a computer monitor. If such alternative embodiment is used, SST/TTS engine(s) 204 may be omitted, and so are the various discussions of “speech.”

STT/TTS engine(s) 204 are either a combined software engine of separate software engines that are configured to convert speech-to-text and text-to-speech, respectively, as known in the art. Every utterance by user 202 may undergo speech-to-text conversion in order for it to be processed by intermediary VA 206 and/or main VA 208, and every textual response from either VA may undergo text-to-speech conversion in order for it to be spoken to the user. Although STT/TTS engine(s) 204 is shown separately from intermediary VA 206 and main VA 208, in practice each of them may include its own STT/TTS engine(s) or they may share the same STT/TTS engine(s).

At a learning stage, intermediary VA 206 intercepts conversations between user 202 and main VA 208 in order to learn from then. This intercepting may be done in different ways. One way is to disable the SST/TTS capabilities of main VA 208, such that only intermediary VA 206 is STT/TTS-active in listening to utterances of user 202 and relaying responses from the main VA to the user. If this method is chosen, then intermediary VA 206 may interface with main VA 208 using a text-based API (Application Program Interface) of the main VA. Another way is to let main VA 208 operate its STT/TTS capabilities normally, and only copy the contents of the conversation between the main VA and user 202 into intermediary VA 206. Either way, intermediary VA 206 accesses main VA 208 and obtains verbatim copies of the utterances and responses.

These intercepted utterances and responses may then serve as a basis for automated learning, by intermediary VA 206, of the task(s) user 202 was performing via such conversation(s) in association with a certain back-end system 210. For example, user 202 may have used main VA 206 to schedule meetings in her computerized calendar, to initiate telephone calls using a telephony service, or to enter data into a database—all being examples of what back-end system 210 may entail. Those of skill in the art will recognize that back-end system 210 may be any computer system which main VA 206 can access via a computer network, a data bus, or the like, in order to perform any type of action a computer can.

One example of a task that may benefit from the present invention is a task of repetitive data entry into a database (the database being part of back-end system 210). Such tasks are common in warehouse inspections, manufacturing inspections, and field inspections, which involve the human inspector entering vast amounts of structured data as to various items she inspects. Using a VA for such repetitive tasks is advantageous, because speaking is often faster than typing, because such tasks often involve the user walking or driving while performing the inspection, making typing hard and slow, and because speaking frees up the user's hands to perform other tasks. With the help of intermediary VA 206, such repetitive task may become even more convenient, and require much simpler and shorter conversations between intermediary VA 206 and user 202, compared to direct conversation between her and main VA 208.

Accordingly, the intercepted utterances and responses may serve as a training set for learning a model which includes entities each having various fields into which values of different types may be entered. The following is an example of an intercepted conversation between user 202 and main VA 208, from which intermediary VA 206 can learn a model. Note that the utterances and responses in this conversation are all either relayed through intermediary VA 206, as shown in FIG. 2, or are at least intercepted and copied by the intermediary VA.

User: “Begin lamp post inspection.”

Main VA: “Lamp post inspection started. Can we begin with lamp post number one?”

User: “OK.”

Main VA: “Please report the height.”

User: “19 inches.”

Main VA: “OK, 19 inches. Please report the condition.”

User: “Working.”

Main VA: “OK, working. Please report light temperature.”

User: “Warm white. Let's move to lamp post number two.”

Main VA: “OK, lamp post number two. lease report the height.”

User: “19 inches.”

Main VA: “OK, 19 inches. Please report the condition.”

User: “Working.”

Main VA: “OK, Working. Please report light temperature.”

User: “Cool white. Let's move to lamp post number three.”

In this exemplary conversation, user 202 enters data as to an entity of the type “lamp post.” Two instances of the entity are discussed, “lamp post number 1” and “lamp post number 2.” For each lamp post, user 202 enters values into the following fields: “height,” “condition,” and “light temperature.” That conversation results in fulfillment of the data entry task by main VA 208, which provides suitable instructions to back-end system 210, and the back-end system returning feedback confirming the data entry.

The conversation can continue, with user 202 entering many different values into the different fields of many lamp posts, so that all possible permutations are eventually covered by the conversation. Based on this conversation—its utterances and responses—intermediary VA 206 may learn the following exemplary model of the entity type “lamp post”:

Entity type: Lamp post.

Entity instance: <serial number from 1 to 1000>.

Field 1 name: Height.

Field 1 type: Numerical.

Field 1 units: Inches.

Field 2 name: Condition.

Field 2 type: Enumerated {Working, Flickering, Out}.

Field 3 name: Light temperature.

Field 3 type: Enumerated {Warm white, Cool white}.

The field types and units are of course not limited to the ones listed above. Field types could be of any data type commonly used by databases and programming languages. Units could be any measurement units which are in common use, either standardized or not.

The learning of the model may be performed according to state-of-the-art techniques such as those of M. Poesio, “A Model of Conversation Processing Based on Micro Conversational Events,” in Proceedings of the 17th Annual Meeting of the Cognitive Science Society, July 1995; or M. Franke, “Quantity Implicatures, Exhaustive Interpretation, and Rational Conversation,” Semantics and Pragmatics 4(1):1-82, October 2011; to name a few examples.

In addition to learning the model, intermediary VA 206 may also learn personal preferences of user 202 as to the task, such as the order at which the fields are traversed, synonyms used by the user to express the same term, instructions that have been repeatedly used by the user and imply some default instruction that can be shortened, etc.

Once intermediary VA 206 learns the model (and optionally the personal preferences), it can begin assisting user 202 in performing the task. When user 202 utters a command or a question, intermediary VA 206 receives the utterance and can adapt it before relaying it to main VA 208. For example, user 202 may utter a relatively short command, and intermediary VA 206 will reformulate it as an elaborate command before relaying it to main VA 208. Moreover, if the command uttered by user 202 necessitates several back-and-forth iterations with main VA 208, then intermediary VA 206 can conduct these iterations in the background, sparing the hassle from the user. Such short commands may be facilitated by way of a predefined vocabulary that is known both to intermediary VA 206 and user 202. The predefined vocabulary may include, for example:

1. A reference statement, such as “same as <previous> except <exceptions>.” The <previous> tag is a placeholder for referring to an entity or to any other item that has previously been mentioned in the conversation with intermediary VA 206. <previous> may be replaced by any other reference statement, such as <the 2^{nd}>, <the entity discussed at 2 pm today>, or the like, to give a few examples.

2. The <exceptions> tag in the reference statement may enumerate one or more fields of an entity instance which should not be duplicated from the entity referred to, but rather receive a different value.

An exemplary use of vocabulary items 1 and 2 is for user 202 to utter: “Lamp post no. 2 is the same as the previous lamp post, except for the light temperature which is cool white.” An even shorter version is possible: “Lamp post no. 2 is the same as the previous lamp post, except for being cool white.”

Based on such short utterance, intermediary VA 206 may formulate an instruction, or a series of instructions, to main VA 208, so that the main VA enters all necessary data with respect to lamp post no. 2 into back-end system 210. For example, the following conversation may take place between intermediary VA 206 and main VA 208:

Intermediary VA: “Let's move to lamp post number two.”

Main VA: “OK, lamp post number two. lease report the height.”

Intermediary VA: “19 inches.”

Main VA: “OK, 19 inches. Please report the condition.”

Intermediary VA: “Working.”

Main VA: “OK, Working. Please report light temperature.”

Intermediary VA: “Cool white.”

Main VA: “OK, Cool white.”

Namely, by uttering a relatively short sentence with only implicit mentions of the “height” and “condition” fields (by a suitable reference statement), intermediary VA 206 is able to relay a comprehensive set of instructions to main VA 208 and essentially conduct multiple different iterations of conversation with the main VA in the background (without user 202 being exposed to them), and the main VA in turn operates back-end system 210 according to these instructions. Also, because that background conversation can be carried out by text-based messages, it only takes a brief moment to complete, not causing any delays noticeable by user 202. Optionally, after main VA 208 has responded to the last instruction and confirmed it was fulfilled with back-end system 210, intermediary VA 206 may utter a formulated response to user 202, confirming the same. For example:

Intermediary VA: “Lamp post number two fully reported as being the same as lamp post number one, except for the color temperature which is cool white.”

The predefined vocabulary may further include, for example:

3. A group statement, such as “<quantifier> <assets> <value> except <exceptions>.” For instance, “every Monday except the 14th.” Such statement may serve as a shortcut to instruct main VA 208, via intermediary VA 206, to perform a complex task, such as schedule a certain recurring meeting with some exceptions to the recurrence.

4. The <quantifier> tag may include words such as “all,” “next <n>” (n being an integer), or a positional word such as “left,”, “bottom,” etc. <assets> could be any one of various entities, such as a day in the above example, or entities such as physical items or abstract terms. <value> is a denominator of the asset, such as the specific day of the week, specific date, or specific physical item, to give a few examples. Lastly, the <exceptions> tag can exclude a certain asset-value pair from the group. See Franke 2011 (id.) for additional discussion of quantifiers in conversations.

Those of skill in the art will recognize that a more comprehensive vocabulary may be developed to suit individual needs; and that as long as such vocabulary is predefined in intermediary VA 206 and reflects how user 202 would naturally phrase her instructions, the user can utilize it to issue shorter commands than would have been possible by conversing with just main VA 208.

In addition, Natural Language Processing (NLP) techniques, as known in the art, may be applied by intermediary VA 206 to utterances of user 202, in order to extract meaningful instructions even from utterances which do not strictly adhere to a predefined vocabulary, or which include terms not being part in the model but are synonymous with terms appearing in the model.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Rather, the computer readable storage medium is a non-transient (i.e., not-volatile) medium.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The description of a numerical range should be considered to have specifically disclosed all the possible subranges as well as individual numerical values within that range. For example, description of a range from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system comprising:
a main virtual assistant (VA) that is configured to operate a back-end system according to instructions; and
an intermediary VA that is configured to:
learn, by conversing with a human user and by analyzing responses from said main VA to the human user, to perform a task that is associated with the back-end system,
hold a conversation with said main VA, wherein, in the conversation, the instructions are formulated and relayed from said intermediary VA to said main VA based on the learning and on further conversing with the human user, such that said main VA operates the back-end system according to the instructions, and
formulate and relay responses to the instructions from said main VA to the human user.

2. The system according to claim 1, wherein the learning by said intermediary VA comprises learning a model which comprises: entities, and fields that can store values for each of the entities.

3. The system according to claim 2, wherein the instructions are formulated and relayed to said main VA based on the learned model.

4. The system according to claim 3, wherein the instructions are with respect to implicit fields and values that are not explicitly mentioned in an utterance of the human user, and the implicit fields and values are deduced from the learned model.

5. The system according to claim 4, wherein said intermediary VA is configured with a vocabulary that, when used in utterances by the human user, enables said intermediary VA to deduce the implicit fields and values.

6. The system according to claim 1, wherein the back-end system is configured to perform at least one of:
store data in a computerized database;
retrieve data from a computerized database; and
provide information to the human user.

7. The system according to claim 1, wherein said intermediary VA is further configured to interface with said main VA using an API (Application Program Interface) of said main VA.

8. The system according to claim 1, wherein each of said main VA and said intermediary VA comprises:
at least one hardware processor, and
a non-transitory computer-readable storage medium having program code embodied therewith, the program code executable by said at least one hardware processor to automatically perform the actions that the main VA or the intermediary VA, respectively, is configured to perform.

9. A method comprising:
accessing a main virtual assistant (VA) that is configured to operate a back-end system according to instructions; and
operating an intermediary VA to:
learn, by conversing with a human user and by analyzing responses from the main VA to the human user, to perform a task that is associated with the back-end system,
hold a conversation with the main VA, wherein, in the conversation, the instructions are formulated and relayed from the intermediary VA to the main VA based on the learning and on further conversing with the human user, such that the main VA operates the back-end system according to the instructions, and
formulate and relay responses to the instructions from the main VA to the human user.

10. The method according to claim 9, wherein the learning by the intermediary VA comprises learning a model which comprises: entities, and fields that can store values for each of the entities.

11. The method according to claim 10, wherein the instructions are formulated and relayed to the main VA based on the learned model.

12. The method according to claim 11, wherein the instructions are with respect to implicit fields and values that are not explicitly mentioned in an utterance of the human user, and the implicit fields and values are deduced from the learned model.

13. The method according to claim 12, wherein the intermediary VA is configured with a vocabulary that, when used in utterances by the human user, enables the intermediary VA to deduce the implicit fields and values.

14. The method according to claim 9, wherein the back-end system is configured to perform at least one of:
store data in a computerized database;
retrieve data from a computerized database; and
provide information to the human user.

15. The method according to claim 9, further comprising operating the intermediary VA to interface with the main VA using an API (Application Program Interface) of the main VA.

16. The method according to claim 9, wherein:
the main VA comprises: at least one hardware processor, and a non-transitory computer-readable storage medium having program code embodied therewith, the program code executable by said at least one hardware processor to automatically operate the back-end system according to the instructions; and
the intermediary VA comprises: a different at least one hardware processor, and a different non-transitory computer-readable storage medium having program code embodied therewith, the program code executable by said different at least one hardware processor to automatically perform the learning, the holding of the conversation, and the formulating and relaying of the responses.

17. A computer program product comprising a non-transitory computer-readable storage medium having program code embodied therewith, the program code executable by at least one hardware processor to:
access a main virtual assistant (VA) that is configured to operate a back-end system according to instructions; and
operate an intermediary VA to:
learn, by conversing with a human user and by analyzing responses from said main VA to the human user, to perform a task that is associated with the back-end system,
hold a conversation with said main VA, wherein, in the conversation, the instructions are formulated and relayed from said intermediary VA to said main VA based on the learning and on further conversing with the human user, such that said main VA operates the back-end system according to the instructions, and
formulate and relay responses to the instructions from said main VA to the human user.

18. The computer program product according to claim 17, wherein:
the learning by said intermediary VA comprises learning a model which comprises: entities, and fields that can store values for each of the entities; and
the instructions are formulated and relayed to said main VA based on the learned model.

19. The computer program product according to claim 18, wherein the instructions are with respect to implicit fields and values that are not explicitly mentioned in an utterance of the human user, and the implicit fields and values are deduced from the learned model.

20. The computer program product according to claim 19, wherein said intermediary VA is configured with a vocabulary that, when used in utterances by the human user, enables said intermediary VA to deduce the implicit fields and values.
